(19) United States
(12) Patent Application Publication
(10) Pub. No.: US 2024/0280701 A1
(43) Pub. Date: Aug. 22, 2024

(54) RANGING DEVICE, MOVING BODY, AND RANGING METHOD

(71) Applicant: KYOCERA Corporation, Kyoto (JP)

(72) Inventor: Shogo MORITA, Yokohama-shi, Kanagawa (JP)

(73) Assignee: KYOCERA Corporation, Kyoto (JP)

(21) Appl. No.: 18/567,610

(22) PCT Filed: Jun. 1, 2022
(86) PCT No.: PCT/JP2022/022381

§ 371 Date: Dec. 6, 2023

(30) Foreign Application Priority Data
Jun. 9, 2021 (JP) 2021-096855

(51) Int. Cl. G01S 17/89; G01S 7/481; G01S 17/931

(52) U.S. Cl. CPC G01S 17/89; G01S 7/4817; G01S 17/931

(57) ABSTRACT

A ranging device, moving body, and ranging method capable of improved estimation accuracy are provided. A ranging device (10) includes an input unit (141), a sampling point estimation unit (147), and a depth estimation unit (146). The input unit acquires input information. The sampling point estimation unit estimates a sampling point in distance information measured as sparse depth, the estimation being based on the input information and performed according to a designated process. The depth estimation unit estimates output information, namely dense depth, on the basis of the distance information. The designated process is determined on the basis of an evaluation using a plurality of the output information estimated by the depth estimation unit.

### CROSS-REFERENCE TO RELATED APPLICATIONS

This application claims priority based on Japanese Patent Application No. 2021-096855 (filed Jun. 9, 2021), the entire disclosure of which is hereby incorporated by reference.

### TECHNICAL FIELD

The present disclosure relates to a ranging device, a moving body, and a ranging method.

### BACKGROUND OF INVENTION

Recent years have seen the development of devices that obtain information about the surroundings from detection results by a plurality of detectors that detect electromagnetic waves. For example, such a device may detect the distance to a subject by using an imaging element to acquire a captured image containing the subject and by detecting electromagnetic waves, including reflected waves reflected by the subject. Distance is also referred to as depth.

In general, the time required to detect the distance for one frame is longer than the time required for the imaging element to acquire a captured image for one frame. Consequently, one way of raising the frame rate is to reduce the number of measurement points (sampling points) at which to detect depth, so that the discrepancy between the position of the subject in the captured image and the position of the subject in the distance information (depth information) does not increase. Known techniques estimate “dense depth” from “sparse depth” to obtain more depth information in the case of few sampling points (see Non-Patent Literature 1 to 3, for example).

### CITATION LIST

### Non Patent Literature

Non Patent Literature 1: Eyal Gofer et al. “Adaptive LiDAR Sampling and Depth Completion using Ensemble Variance.” arXiv:2007.13834 (2020)

Non-Patent Literature 2: A. W. Bergman, D. B. Lindell, and G. Wetzstein. “Deep adaptive lidar: End-to-end optimization of sampling and depth completion at low sampling rates.” IEEE International Conference on Computational Photography. IEEE, 2020, pp. 1-11

Non-Patent Literature 3: A. Wolff, S. Praisler, I. Tcenov, and G. Gilboa. “Super-pixel sampler: a data-driven approach for depth sampling and reconstruction.” IEEE International Conference on Robotics and Automation. IEEE, 2020

### SUMMARY

According to one embodiment of the present disclosure, a ranging device includes an input unit, a sampling point estimation unit, and a depth estimation unit. The input unit acquires input information. The sampling point estimation unit estimates a sampling point in distance information measured as sparse depth. The estimation is based on the input information and is performed according to a designated process. The depth estimation unit estimates output information, namely dense depth, on the basis of the distance information. The designated process is determined on the basis of an evaluation using a plurality of the output information estimated by the depth estimation unit.

According to one embodiment of the present disclosure, a moving body includes the above ranging device.

According to one embodiment of the present disclosure, a moving body includes a communication unit and an external device. The communication unit transmits input information to the ranging device and receives output information estimated by the ranging device on the basis of the input information. The external device controls the moving body on the basis of the output information or notifies a driver of the moving body on the basis of the output information.

According to one embodiment of the present disclosure, a ranging method includes inputting, estimating a sampling point, and estimating depth. The inputting involves acquiring input information. The estimating of a sampling point involves estimating a sampling point in distance information measured as sparse depth. The estimation is based on the input information and is performed according to a designated process. The estimating of depth involves estimating, output information, namely dense depth, on the basis of the distance information. The designated process is determined on the basis of an evaluation using a plurality of estimated output information.

### BRIEF DESCRIPTION OF THE DRAWINGS

FIG. 1 is a configuration diagram illustrating a schematic configuration of a ranging device according to an embodiment.

FIG. 2 is a diagram for explaining the direction of travel of electromagnetic waves in first and second stages of the ranging device in FIG. 1.

FIG. 3 is a diagram for explaining the detection of electromagnetic waves including reflected waves.

FIG. 4 is a timing chart for explaining distance computation.

FIG. 5 is a diagram for explaining improvement in estimation accuracy.

FIG. 6 is a diagram for explaining dense depth estimation performed by the ranging device in FIG. 1.

FIG. 7 is a diagram for explaining sampling point calculation.

FIG. 8 is a diagram for explaining the generation of a sampling point estimation model.

FIG. 9 is a flowchart illustrating a process for generating a sampling point estimation model.

FIG. 10 is a flowchart illustrating a ranging method according to an embodiment.

### DESCRIPTION OF EMBODIMENTS

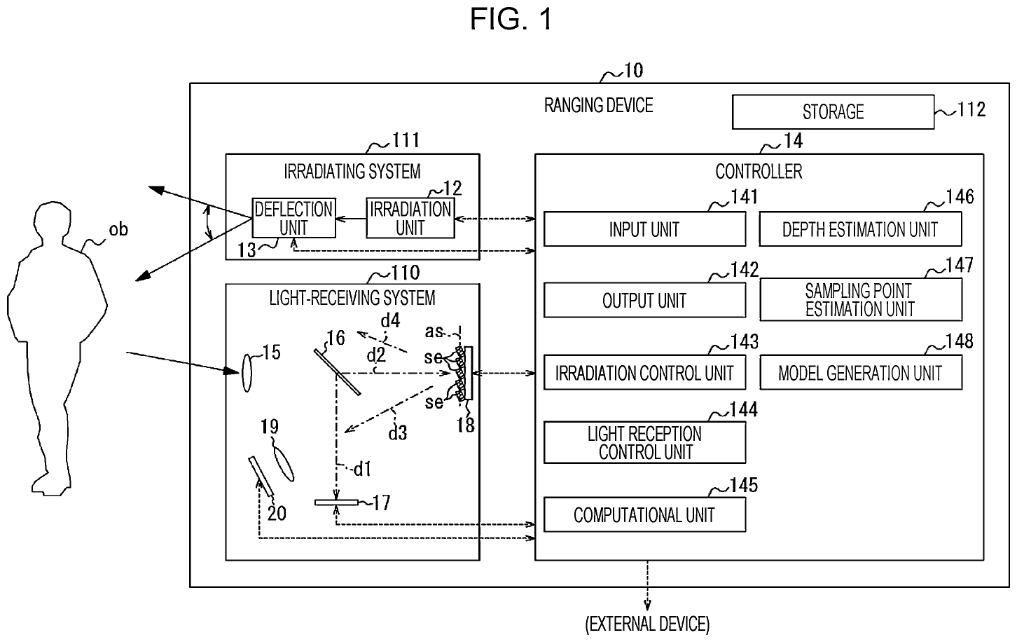

FIG. 1 is a configuration diagram illustrating a schematic configuration of a ranging device 10 according to an embodiment. The ranging device 10 includes an irradiating system 111, a light-receiving system 110, storage 112, and a controller 14. The present embodiment describes the ranging device 10 as including one irradiating system 111 and one light-receiving system 110, but the ranging device 10 is not limited to one each of the irradiating system 111 and the light-receiving system 110. The ranging device 10 may be configured such that each of a plurality of light-receiving systems 110 is associated with a corresponding one of a plurality of irradiating systems 111.

The irradiating system 111 includes an irradiation unit 12 and a deflection unit 13. The light-receiving system 110 includes an incidence unit 15, a separation unit 16, a first detection unit 20, a second detection unit 17, a switching unit 18, and a first downstream optical system 19. The controller 14 includes an input unit 141, an output unit 142, an irradiation control unit 143, a light reception control unit 144, a computational unit 145, a depth estimation unit 146, a sampling point estimation unit 147, and a model generation unit 148. This description later gives details regarding each function block of the ranging device 10 according to the present embodiment.

In the drawings, the dashed lines joining function blocks indicate the flow of control signals or communicated information. The communication indicated by the dashed lines may be wired communication or wireless communication. The solid arrows indicate beam electromagnetic waves. In the drawings, the object ob is a subject of the ranging device 10. The subject may include a thing such as a road, median strip, sidewalk, roadside tree, vehicle, or the like. The subject may also include a person. The object ob is not limited to being singular.

The ranging device 10 can identify the subject by acquiring an image containing the subject and detecting reflected waves reflected by the subject. In the present embodiment, the ranging device 10 uses the computational unit 145 to measure the distance to the object ob. For example, the ranging device 10 may be installed in a vehicle or the like and be used for driving assistance that notifies the driver upon detecting the object ob nearby during travel. Distance is also referred to as depth. In the following, the wording “depth” can be replaced with “distance”.

The time required to detect the distance for one frame is longer than the time required to acquire a captured image for one frame. Consequently, one way of raising the frame rate is to reduce the number of sampling points at which to detect depth, so that the discrepancy between the position of the subject in the captured image and the position of the subject in the distance information (depth information) does not increase. The distance (depth) measured directly is “sparse depth”. As described later, the ranging device 10 estimates output information, namely “dense depth”, on the basis of distance information measured as sparse depth. In other words, in the present embodiment, the ranging device 10 measures the distance to the object ob, estimates dense depth on the basis of the measured sparse depth, and outputs the estimated dense depth. The outputted dense depth may be used in driving assistance, such as determining proximity to, and predicting the movement of, the object ob, for example. Dense depth contains more depth than the sparse depth measured directly. Dense depth may contain depth corresponding to each pixel of a captured image, for example. However, insofar as the dense depth contains more depth than the sparse depth, the dense depth does not necessarily contain depth corresponding to each pixel of a captured image.

### Irradiating System

The irradiating system 111 uses electromagnetic waves to irradiate a space where the object ob is present. In the present embodiment, the irradiating system 111 radiates electromagnetic waves radiated by the irradiation unit 12 through the deflection unit 13 toward the space where the object ob is present. As another example of the irradiating system 111, the irradiation unit 12 may radiate electromagnetic waves directly toward the object ob.

The irradiation unit 12 radiates at least one from among infrared rays, visible light rays, ultraviolet rays, and radio waves. In the present embodiment, the irradiation unit 12 radiates infrared rays. In the present embodiment, the irradiation unit 12 radiates electromagnetic waves in a narrow beam of 0.5°, for example. The irradiation unit 12 radiates pulsed electromagnetic waves. The irradiation unit 12 may include, for example, a light-emitting diode (LED) as an electromagnetic wave-radiating element. The irradiation unit 12 may include, for example, a laser diode (LD) as an electromagnetic wave-radiating element. The irradiation unit 12 switches between radiating and stopping electromagnetic waves under control by the controller 14. The irradiation unit 12 may include an LED array or LD array in which a plurality of electromagnetic wave-radiating elements are arranged in an array. With this configuration, the irradiation unit 12 may radiate a plurality of beams at the same time.

The deflection unit 13 causes electromagnetic waves radiated by the irradiation unit 12 to be outputted in a plurality of different directions, thereby changing the irradiated position to be irradiated by electromagnetic waves in the space where the object ob is present. To output in a plurality of different directions, the deflection unit 13 may reflect electromagnetic waves from the irradiation unit 12 while altering the direction of the electromagnetic waves. For example, the deflection unit 13 scans the object ob one-dimensionally or two-dimensionally. In one example, the irradiation unit 12 is configured as an LD array. In this case, the deflection unit 13 reflects all of a plurality of beams outputted from the LD array and outputs the reflected beams in the same direction. That is, the irradiating system 111 has one deflection unit 13 with respect to the irradiation unit 12 which has one or a plurality of electromagnetic wave-radiating elements.

The deflection unit 13 is configured such that at least a portion of the irradiated area, that is, the space in which electromagnetic waves are outputted, is included in the electromagnetic wave detection range of the light-receiving system 110. Consequently, at least a portion of the electromagnetic waves radiated via the deflection unit 13 into the space where the object ob is present may be reflected by at least a portion of the object ob and detected in the light-receiving system 110. The electromagnetic waves generated due to at least a portion of the object ob reflecting electromagnetic waves outputted from the deflection unit 13 are referred to as reflected waves.

The deflection unit 13 includes a microelectromechanical systems (MEMS) mirror, a polygon mirror, or a galvano mirror, for example. In the present embodiment, the deflection unit 13 includes a MEMS mirror.

The deflection unit 13 alters the reflection direction of electromagnetic waves under control by the controller 14. The deflection unit 13 may also include an angle sensor such as an encoder, for example. The deflection unit 13 may send to the controller 14 a notification including an angle detected by the angle sensor as information on the reflection direction of electromagnetic waves. In such a configuration, the controller 14 may use the direction information obtained from the deflection unit 13 as a basis for calculating the irradiated position to be irradiated by electromagnetic waves. The controller 14 may also calculate the irradiated position on the basis of a drive signal to be inputted into the deflection unit 13 to alter the reflection direction of electromagnetic waves.

### Light-Receiving System

In the following, “electromagnetic waves including reflected waves” means electromagnetic waves, including waves reflected by the object ob, that are incident on the light-receiving system 110. That is, electromagnetic waves incident on the light-receiving system 110 may be referred to as “electromagnetic waves including reflected waves” to distinguish from electromagnetic waves radiated from the irradiating system 111. The electromagnetic waves including reflected waves include not only reflected waves generated due to the object ob reflecting electromagnetic waves radiated from the irradiating system 111, but also sunlight or other outside light, light generated due to the object ob reflecting outside light, and the like.

The incidence unit 15 is an optical system including at least one optical member. The incidence unit 15 forms an image of the object ob which serves as the subject. The optical member includes at least one from among a lens, a mirror, an aperture, and an optical filter, for example.

The separation unit 16 is located between the incidence unit 15 and a primary image formation position. The primary image formation position is the position where an image of the object ob is formed by the incidence unit 15 at a predetermined distance from the incidence unit 15. The separation unit 16 separates the electromagnetic waves including reflected waves according to wavelength, so that the waves travel in a first direction d1 or a second direction d2.

In the present embodiment, the separation unit 16 reflects a portion of the electromagnetic waves including reflected waves in the first direction d1, and transmits a different portion in the second direction d2. In the present embodiment, the portion of incident electromagnetic waves that the separation unit 16 reflects in the first direction d1 is visible light generated due to the object ob reflecting ambient light such as sunlight. The portion of incident electromagnetic waves that the separation unit 16 transmits in the second direction d2 are infrared rays generated due to the object ob reflecting infrared rays radiated by the irradiation unit 12. As a different example, the separation unit 16 may transmit a portion of incident electromagnetic waves in the first direction d1 and reflect a different portion of the electromagnetic waves in the second direction d2. The separation unit 16 may refract a portion of incident electromagnetic waves in the first direction d1 and refract a different portion of the electromagnetic waves in the second direction d2. The separation unit 16 is, for example, a one-way mirror, a beam splitter, a dichroic mirror, a cold mirror, a hot mirror, a metasurface, a deflector, or a prism.

The second detection unit 17 is located on the path of electromagnetic waves traveling in the first direction d1 from the separation unit 16. The second detection unit 17 is located at or near the image formation position of the object ob in the first direction d1. The second detection unit 17 detects electromagnetic waves traveling in the first direction d1 from the separation unit 16.

The second detection unit 17 may be disposed relative to the separation unit 16 so that a first axis of travel of electromagnetic waves traveling in the first direction d1 from the separation unit 16 is parallel to a first detection axis of the second detection unit 17. The first axis of travel is the central axis of electromagnetic waves that propagate while spreading out radially as the waves travel in the first direction d1 from the separation unit 16. In the present embodiment, the first axis of travel is the axis in which the optical axis of the incidence unit 15 extends to the separation unit 16 and is bent at the separation unit 16 to be parallel to the first direction d1. The first detection axis is the axis passing through the center of a detection surface of the second detection unit 17, perpendicular to the detection surface.

The second detection unit 17 may be disposed so that the spacing between the first axis of travel and the first detection axis is less than or equal to a first spacing threshold. The second detection unit 17 may also be disposed so that the first axis of travel and the first detection axis are aligned. In the present embodiment, the second detection unit 17 is disposed so that the first axis of travel and the first detection axis are aligned.

The second detection unit 17 may also be disposed relative to the separation unit 16 so that a first angle between the first axis of travel and the detection surface of the second detection unit 17 is less than or equal to a first angle threshold, or is a predetermined angle. In the present embodiment, the second detection unit 17 is disposed so that the first angle is 90°.

In the present embodiment, the second detection unit 17 is a passive sensor. In the present embodiment, the second detection unit 17 more specifically includes an element array. For example, the second detection unit 17 includes an imaging element such as an image sensor or an imaging array. The second detection unit 17 captures an image from electromagnetic waves forming an image on the detection surface, and generates image information about the space containing the imaged object ob.

In the present embodiment, the second detection unit 17 more specifically captures a visible light image. The second detection unit 17 transmits the generated image information as a signal to the controller 14. The second detection unit 17 may capture an image of other than visible light, such as an image of infrared rays, ultraviolet rays, or radio waves.

The switching unit 18 is located on the path of electromagnetic waves traveling in the second direction d2 from the separation unit 16. The switching unit 18 is located at or near the primary image formation position of the object ob in the second direction d2.

In the present embodiment, the switching unit 18 is located at the image formation position. The switching unit 18 has an active surface as on which electromagnetic waves passing through the incidence unit 15 and the separation unit 16 are incident. The active surface as is formed from a plurality of switching elements se arranged two-dimensionally. The active surface as is a surface that produces an effect, such as reflection and transmission, on electromagnetic waves in at least one of a first state or a second state described below.

The switching unit 18 can switch each switching element se between first and second states. The first state causes electromagnetic waves incident on the active surface as to travel in a third direction d3, while the second state causes the waves to travel in a fourth direction d4. In the present embodiment, the first state is a first reflecting state that reflects electromagnetic waves incident on the active surface as in the third direction d3. The second state is a second reflecting state that reflects electromagnetic waves incident on the active surface as in the fourth direction d4.

In the present embodiment, the switching unit 18 more specifically includes a reflection surface that reflects electromagnetic waves for each switching element se. The switching unit 18 freely changes the direction of the reflection surface of each switching element se to thereby switch each switching element se between the first and second reflecting states.

In the present embodiment, the switching unit 18 includes a digital micromirror device (DMD), for example. The DMD can drive the minute reflection surfaces forming the active surface as and thereby switch the reflection surface to either +12° or −12° inclination with respect to the active surface as for each switching element se. The active surface as is parallel to the board surface of a substrate bearing the minute reflection surfaces in the DMD.

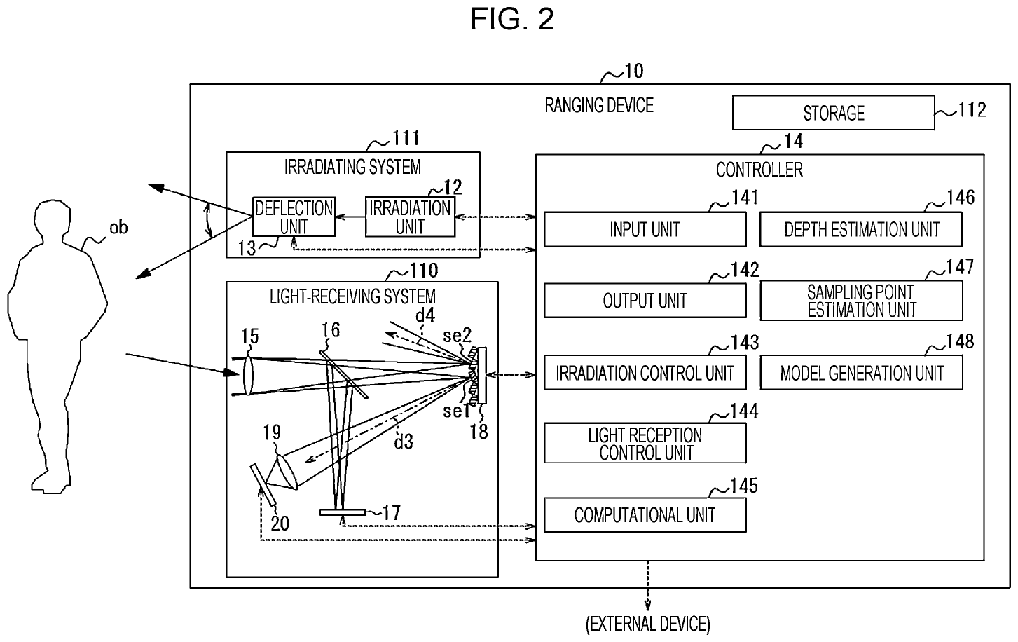

The switching unit 18 switches each switching element se between the first and second states under control by the controller 14. For example, as illustrated in FIG. 2, the switching unit 18 may switch a portion of switching elements se1 to the first state to cause electromagnetic waves incident on the switching elements se1 to travel in the third direction d3. At the same time, the switching unit 18 may switch a different portion of switching elements se2 to the second state to cause electromagnetic waves incident on the switching elements se2 to travel in the fourth direction d4. More specifically, the controller 14 detects the direction in which electromagnetic waves were radiated or the position irradiated by electromagnetic waves, on the basis of direction information from the deflection unit 13. The controller 14 sets the switching elements se1 corresponding to the detected radiation direction or irradiated position of the electromagnetic waves to the first state, and sets all other switching elements se1 to the second state. Thus, the controller 14 selectively causes reflected waves from the object ob to travel in the third direction d3. Among the electromagnetic waves passing through the separation unit 16, electromagnetic waves other than reflected waves from the object ob travel in the fourth direction d4, and thus are not incident on the first detection unit 20.

As illustrated in FIG. 1, the first downstream optical system 19 is located in the third direction d3 from the switching unit 18. The first downstream optical system 19 includes at least one from among a lens and a mirror, for example. The first downstream optical system 19 forms an image of the object ob as electromagnetic waves traveling in a direction switched in the switching unit 18.

The first detection unit 20 detects reflected waves. The first detection unit 20 is disposed at a position allowing for the detection of electromagnetic waves traveling through the first downstream optical system 19 after traveling in the third direction d3 due to the switching unit 18. The first detection unit 20 detects electromagnetic waves through the first downstream optical system 19, or in other words electromagnetic waves traveling in the third direction d3, and outputs a detection signal.

The first detection unit 20 and the switching unit 18 may be disposed relative to the separation unit 16 so that a second axis of travel of electromagnetic waves traveling in the second direction d2 from the separation unit 16 and switched to the third direction d3 by the switching unit 18 is parallel to a second detection axis of the first detection unit 20. The second axis of travel is the central axis of electromagnetic waves that propagate while spreading out radially as the waves travel in the third direction d3 from the switching unit 18. In the present embodiment, the second axis of travel is the axis in which the optical axis of the incidence unit 15 extends to the switching unit 18 and is bent at the switching unit 18 to be parallel to the third direction d3. The second detection axis is the axis passing through the center of a detection surface of the first detection unit 20, perpendicular to the detection surface.

The first detection unit 20 and the switching unit 18 may be disposed so that the spacing between the second axis of travel and the second detection axis is less than or equal to a second spacing threshold. The second spacing threshold may be the same value as the first spacing threshold or a different value. The first detection unit 20 may also be disposed so that the second axis of travel and the second detection axis are aligned. In the present embodiment, the first detection unit 20 is disposed so that the second axis of travel and the second detection axis are aligned.

The first detection unit 20 and the switching unit 18 may also be disposed relative to the separation unit 16 so that a second angle between the second axis of travel and the detection surface of the first detection unit 20 is less than or equal to a second angle threshold, or is a predetermined angle. The second angle threshold may be the same value as the first angle threshold or a different value. In the present embodiment, the first detection unit 20 is disposed so that the second angle is 90°, as described above.

In the present embodiment, the first detection unit 20 is an active sensor that detects reflected waves of electromagnetic waves radiated from the irradiation unit 12 toward the object ob. The first detection unit 20 includes a single element, such as an avalanche photodiode (APD), a photodiode (PD), or a ranging image sensor, for example. The first detection unit 20 may include an element array, such as an APD array, a PD array, a ranging imaging array, or a ranging image sensor.

In the present embodiment, the first detection unit 20 transmits detection information as a signal to the controller 14. The detection information indicates that reflected waves from the subject have been detected. The first detection unit 20 more specifically detects electromagnetic waves in the infrared band.

In the present embodiment, the first detection unit 20 is used as a detection element for measuring the distance to the object ob. In other words, the first detection unit 20 is an element that forms a ranging sensor, and an image is not necessarily formed on the detection surface insofar as electromagnetic waves can be detected. Therefore, the first detection unit 20 is not necessarily provided at a secondary image formation position, that is, the position of image formation by the first downstream optical system 19. In other words, in this configuration, the first detection unit 20 may be disposed anywhere on the path of electromagnetic waves traveling through the first downstream optical system 19 after traveling in the third direction d3 due to the switching unit 18, insofar as the first detection unit 20 is at a position where the electromagnetic waves can be incident on the detection surface from the entire angle of view.

By having a configuration like the above, the ranging device 10 aligns a predetermined position in an image with the optical axis of reflected waves for measuring the distance to that position.

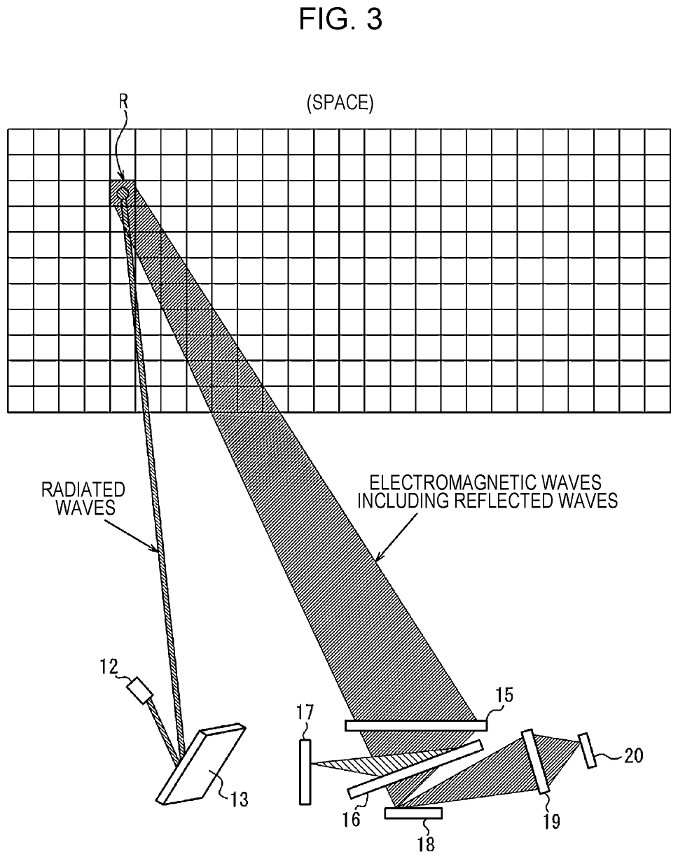

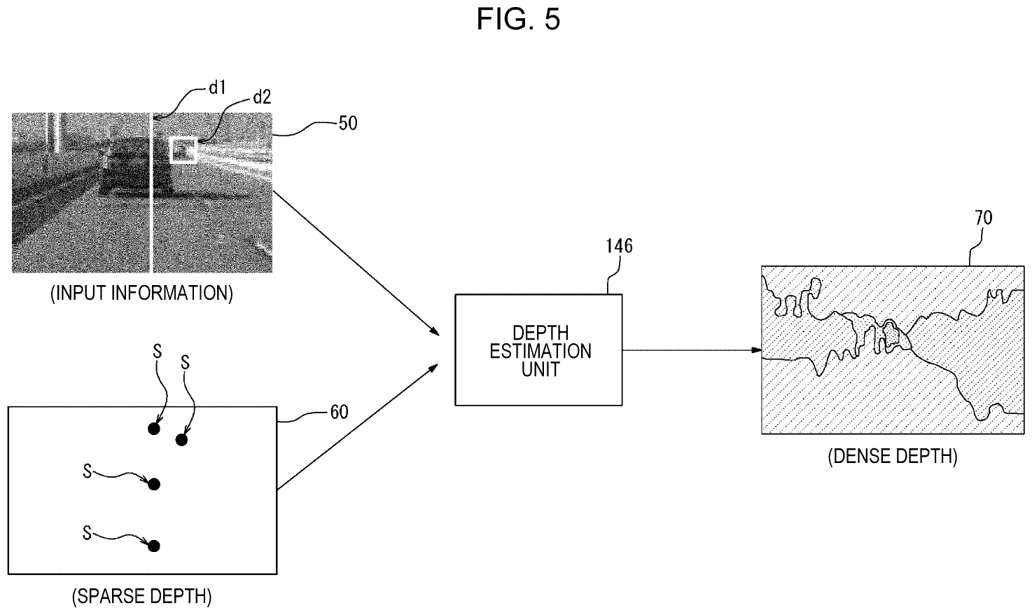

FIG. 3 is a diagram for explaining the detection of electromagnetic waves including reflected waves. In FIG. 3, the space where the object ob is present is The space is sectioned into a grid divided by the number of times per frame that the irradiating system 111 radiates electromagnetic waves. In general, the time required to detect electromagnetic waves including reflected waves for one frame is longer than the time required to acquire a captured image 50 (see FIG. 5) for one frame by an imaging element or the like. In the example in FIG. 3, beam electromagnetic waves radiated from the irradiation unit 12 are reflected by the deflection unit 13 and incident as irradiating waves on a single region R in the space. Electromagnetic waves including reflected waves reflected by the object ob in the region R are incident on the incidence unit 15. In the present embodiment, the reflected waves are infrared rays. The electromagnetic waves including reflected waves include visible light due to the reflection of outside light by the object ob present in the region R. The separation unit 16 reflects visible light among the electromagnetic waves including reflected waves in the first direction d1. The second detection unit 17 detects the reflected visible light. The separation unit 16 transmits infrared rays among the electromagnetic waves including reflected waves in the second direction d2. The switching unit 18 reflects the infrared rays transmitted through the separation unit 16. At least a portion of the reflected infrared rays travel in the third direction d3. The infrared rays traveling in the third direction d3 pass through the first downstream optical system 19 and are detected by the first detection unit 20.

### Storage

The storage 112 may function as a memory to store various information. The storage 112 may store, for example, a program to be executed in the controller 14 and the result of a process executed in the controller 14. The storage 112 may function as a working memory of the controller 14. The storage 112 can be configured as a semiconductor memory, for example, but is not limited thereto, and can be any storage device. As another example, the storage 112 may be an internal memory of a processor provided in the controller 14, or an external storage device connected to the controller 14.

The storage 112 may store trained models generated by the model generation unit 148. In the present embodiment, the trained models include a depth estimation model and a sampling point estimation model described later.

### Controller

The input unit 141 acquires input information. The input information is data to be used in a process by which the ranging device 10 estimates dense depth. In the present embodiment, the input information is image information from the second detection unit 17. The image information is of the space where the object ob is present. The input unit 141 may include a buffer for temporarily storing input information. The buffer is a semiconductor memory or a magnetic memory, for example.

The output unit 142 outputs output information. The output information is dense depth estimated by the ranging device 10. In the present embodiment, the output unit 142 outputs the output information to an external device different from the ranging device 10. The external device may be a device that notifies the driver upon detecting danger, for example. For example, the external device may determine proximity to an oncoming vehicle, obstacle, or the like on the basis of output information outputted by the output unit 142. If evasive action is necessary, the external device may issue a notification or warning. The external device may be a device that controls a vehicle. For example, the external device may control a vehicle equipped with the ranging device 10 to maintain a following distance from a vehicle ahead on the basis of output information outputted by the output unit 142. In other words, the external device may use output information outputted by the output unit 142 to perform adaptive cruise control or the like. When the output information indicates the distance to an obstacle, the external device may control the vehicle to avoid the obstacle on the basis of the output information. “External” in external device herein means that the device is separate from the ranging device 10, and does not limit the place where the device is located.

The irradiation control unit 143 controls the irradiating system 111. For example, the irradiation control unit 143 causes the irradiation unit 12 to switch between radiating and stopping electromagnetic waves. For example, the irradiation control unit 143 causes the deflection unit 13 to alter the reflection direction of electromagnetic waves. As described in detail later, the irradiation control unit 143 controls the irradiating system 111 to radiate electromagnetic waves to a sampling point estimated by the sampling point estimation unit 147 (that is, an effective sampling point for the depth estimation unit 146).

The light reception control unit 144 controls the light-receiving system 110. For example, the light reception control unit 144 causes the switching unit 18 to switch each switching element se between the first and second states.

The computational unit 145 computes the distance to the object ob on the basis of detection information from the first detection unit 20. The detection information from the first detection unit 20 is distance information (depth information). The computational unit 145 can compute distance on the basis of acquired detection information according to the time-of-flight (ToF) method, for example.

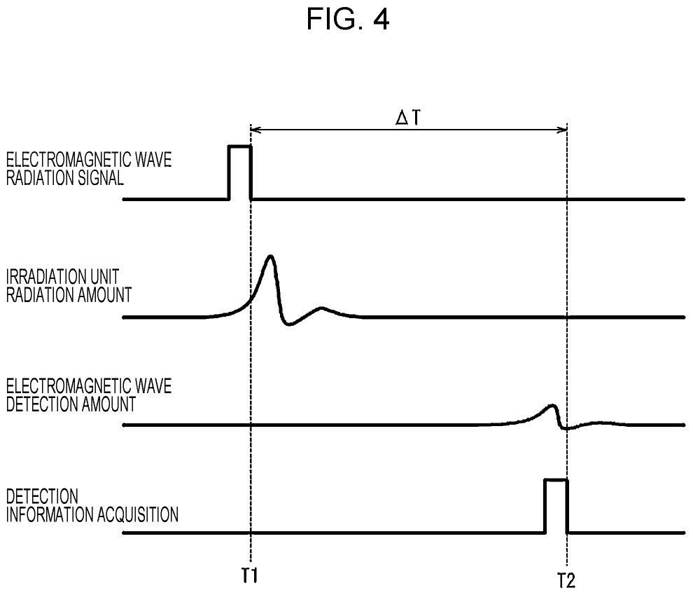

As illustrated in FIG. 4, the controller 14 inputs an electromagnetic wave radiation signal into the irradiation unit 12, which causes the irradiation unit 12 to radiate pulsed electromagnetic waves (see the “electromagnetic wave radiation signal” section). The irradiation unit 12 radiates electromagnetic waves on the basis of the inputted electromagnetic wave radiation signal (see the “irradiation unit radiation amount” section). The electromagnetic waves radiated by the irradiation unit 12 and reflected by the deflection unit 13 irradiate the irradiated area, that is, the space where the object ob is present, and are reflected in the irradiated area. The controller 14 switches at least a portion of the switching elements se in the switching unit 18 to the first state and switches the other switching elements to the second state. The switching elements se switched to the first state are inside an image formation area created by the incidence unit 15 with reflected waves from the irradiated area. Upon detecting electromagnetic waves reflected in the irradiated area (see the “electromagnetic wave detection amount” section), the first detection unit 20 sends a notification including the detection information to the controller 14.

The computational unit 145 acquires information in the above signal including the detection information. The computational unit 145 includes a large-scale integration (LSI) timekeeping circuit, for example, and measures the time AT from a time T1 when the irradiation unit 12 radiates electromagnetic waves to a time T2 when the detection information is acquired (see the “detection information acquisition” section). The computational unit 145 multiplies the time AT by the speed of light and divides by 2 to calculate the distance to the irradiated position.

The depth estimation unit 146 estimates dense depth on the basis of sparse depth. The depth estimation unit 146 may be configured using a model that accepts the input of information including sparse depth, and outputs estimated dense depth. The model may be a numerical model or a machine learning model. In the present embodiment, the depth estimation unit 146 is configured using a trained machine learning model (depth estimation model) generated by the model generation unit 148. When executing estimation, the depth estimation unit 146 may read out the depth estimation model from the storage 112. In the present embodiment, the depth estimation unit 146 uses input information in addition to sparse depth as the information to accept as input. In other words, in the present embodiment, the depth estimation model accepts information on sparse depth and input information (image information) as input, and outputs estimated dense depth.

The sampling point estimation unit 147 estimates a sampling point in distance information measured as sparse depth. In the present embodiment, information on the sampling point estimated by the sampling point estimation unit 147 is communicated to the irradiation control unit 143, and the irradiation control unit 143 controls the irradiating system 111 to irradiate the estimated sampling point with electromagnetic waves. The sampling point estimation unit 147 estimates an effective sampling point for the depth estimation unit 146 on the basis of input information according to a designated process. The sampling point estimation unit 147 may be configured using a model that accepts input information as input, and outputs an estimated sampling point. The model may be a numerical model or a machine learning model. In the present embodiment, the sampling point estimation unit 147 is configured using a trained machine learning model (sampling point estimation model) generated by the model generation unit 148. When executing estimation, the sampling point estimation unit 147 may read out the sampling point estimation model from the storage 112.

The designated process to be executed using the sampling point estimation model is determined on the basis of an evaluation using a plurality of output information estimated by the depth estimation unit 146. Although details are described later, by determining the designated process on the basis of an estimation result from the depth estimation unit 146, the sampling point estimation unit 147 can estimate an effective sampling point for the depth estimation unit 146. In the present embodiment, the sampling point estimation model is generated by machine learning using training data generated on the basis of the above evaluation.

The model generation unit 148 generates the depth estimation model and the sampling point estimation model in a learning phase. As above, in the present embodiment, these models are generated by machine learning using training data. The phases in which the ranging device 10 executes processing are divided into a “learning phase” and an “estimating phase”. In the estimating phase, the ranging device 10 estimates dense depth using input information and the like obtained in real time. The learning phase occurs prior to the estimating phase (before the execution of dense depth estimation). In the learning phase, the model generation unit 148 generates the models as above.

In the present embodiment, the model generation unit 148 generates the depth estimation model and the sampling point estimation model through machine learning using training data. The machine learning technique is not particularly limited insofar as the technique involves a regression analysis of the relationship between inputs and outputs. For example, a technique such as a neural network or a random forest may be used.

The controller 14 may include at least one processor. The processor may load a program from an accessible memory (for example, the storage 112) to operate as the input unit 141, output unit 142, irradiation control unit 143, light reception control unit 144, computational unit 145, depth estimation unit 146, sampling point estimation unit 147, and model generation unit 148. The processor may include at least one from among a general-purpose processor that loads a specific program to execute a specific function and a special-purpose processor dedicated to a specific process. The special-purpose processor may include an application-specific integrated circuit (ASIC). The processor may include a programmable logic device (PLD). The PLD may include a field-programmable gate array (FPGA). The controller 14 may also include at least one from among a system-on-a-chip (SoC) and a system in a package (SiP) in which one or more processors cooperate.

### Depth Estimation

In a depth estimation model that accepts the input of information containing sparse depth and outputs estimated dense depth, the accuracy of the dense depth estimation generally depends on the positions of the sparse depth sampling points. In the case of inputting sparse depth information and image information into the depth estimation model like in the present embodiment, the positions of the sparse depth sampling points correspond to portions where the distance is difficult to determine on the basis of the image information. This configuration improves the estimation accuracy with respect to the estimated dense depth.

FIG. 5 is a diagram for explaining improvement in estimation accuracy as above. FIG. 5 illustrates a captured image 50 that corresponds to input information (image information). FIG. 5 also illustrates a “sparse depth image 60” indicating sparse depth in association with the captured image 50. FIG. 5 also illustrates a “dense depth image 70” indicating dense depth in association with the captured image 50. In the captured image 50, blown highlights d1 may occur due to the influence of strong light such as sunlight, for example. In the captured image 50, an indistinct portion d2 may occur at far distances or the like where light does not reach. By associating the positions of the sparse depth sampling points (S in FIG. 5) with the blown highlights d1 and the indistinct portion d2, the depth estimation unit 146 can ascertain the distance (depth) of the blown highlights d1 and the indistinct portion d2. This configuration improves the estimation accuracy of the dense depth estimated by the depth estimation unit 146.

Such sparse depth sampling points (S in FIG. 5) are “effective sampling points” for the depth estimation unit 146 that improve the estimation accuracy of the dense depth. The effective sampling points depend on the depth estimation model that the depth estimation unit 146 uses. Although details are described later, the designated process that the sampling point estimation model is to execute is determined on the basis of an evaluation of a plurality of output information (dense depth) estimated by the depth estimation unit 146.

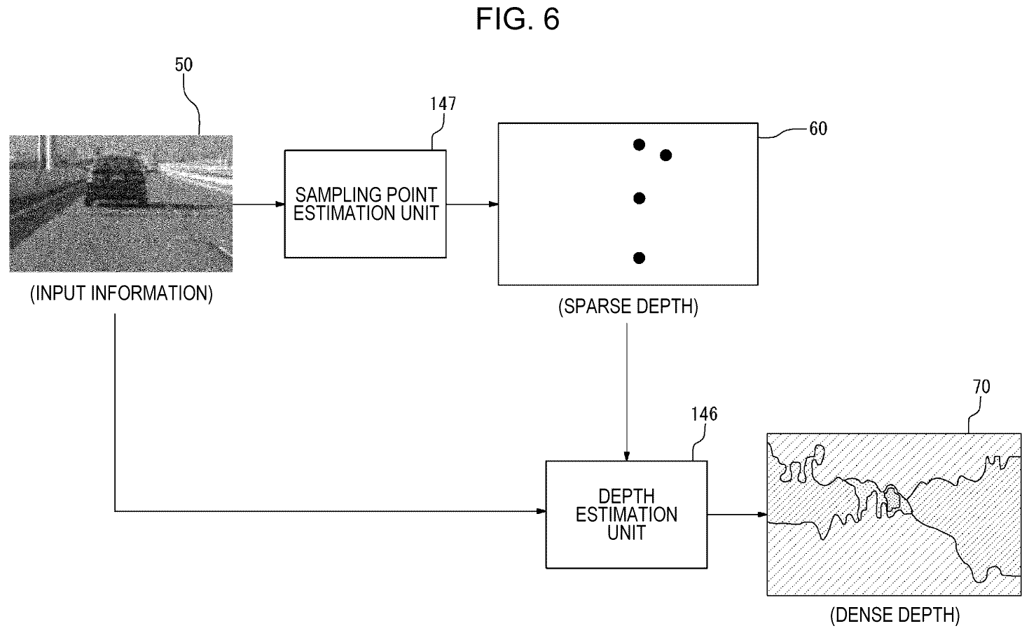

FIG. 6 is a diagram for explaining dense depth estimation performed by the ranging device 10 according to the present embodiment in the estimating phase. The input unit 141 acquires image information as input information. From the image information, the sampling point estimation unit 147 estimate a sampling point in distance information measured as sparse depth. The estimated sampling point is an effective sampling point for the depth estimation unit 146. The irradiation control unit 143 controls the irradiating system 111 to radiate electromagnetic waves to the sampling point estimated by the sampling point estimation unit 147. The computational unit 145 computes the distance (depth) to the object ob at the sampling point on the basis of detection information from the first detection unit 20, and outputs the computed result as sparse depth to the depth estimation unit 146. The depth estimation unit 146 estimates dense depth with high accuracy from the image information and the sparse depth. In the estimation of dense depth performed by the ranging device 10, the distance (depth) to be estimated is sparse depth. This allows for raising the frame rate of ranging. The depth estimation unit 146 can be configured using a single model (depth estimation model). This allows for fast computation. Therefore, in the present embodiment, the ranging device 10 is suitable for real-time measurement.

### Model Generation

As above, in the learning phase, the model generation unit 148 generates the depth estimation model and the sampling point estimation model through machine learning using training data. Of these models, the depth estimation model may be generated using deep learning, for example. As another example, the depth estimation model may utilize a previously generated model. The sampling point estimation model is generated as follows using the output of the depth estimation model.

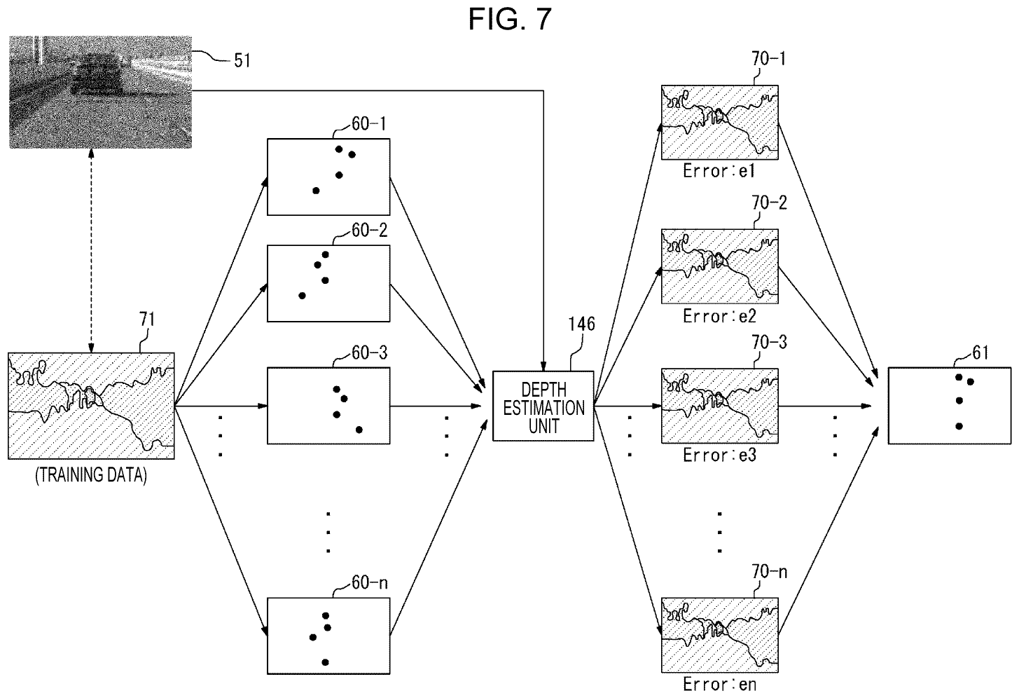

FIG. 7 is a diagram for explaining effective sampling point calculation using a depth estimation model. First, training data is prepared. The training data contains image information and dense depth corresponding to the image information. FIG. 7 illustrates a “captured image 51” that corresponds to image information. FIG. 7 also illustrates a “dense depth image 71” indicating dense depth training data in association with the captured image 51.

The model generation unit 148 generates a plurality of sparse depth data from the dense depth training data. The sparse depth images 60-1 to 60-n (where n is an integer equal to or greater than 2) in FIG. 7 are depth images of a plurality of sparse depth data. The plurality of sparse depth data is generated so that the sampling points differ from one another. The model generation unit 148 may generate a plurality of sparse depth data from the dense depth training data by using a genetic algorithm, for example.

The model generation unit 148 sequentially inputs the plurality of sparse depth data into the depth estimation model of the depth estimation unit 146, and causes the depth estimation unit 146 to output a plurality of dense depth data. The dense depth images 70-1 to 70-n in FIG. 7 are depth images of a plurality of dense depth data. The model generation unit 148 evaluates each of the plurality of dense depth data. In the example in FIG. 7, the evaluation may involve comparing each of the plurality of dense depth data to the dense depth training data, obtaining non-matching portions as errors, and calculating the number or magnitude of errors as an evaluation value (Error:e1 to Error:en in FIG. 7). The model generation unit 148 calculates effective sampling points for the depth estimation unit 146 on the basis of the correspondence relationship between the above evaluation and the plurality of sparse depth data. The sparse depth image 61 in FIG. 7 is an image representation of sparse depth data containing calculated sampling points.

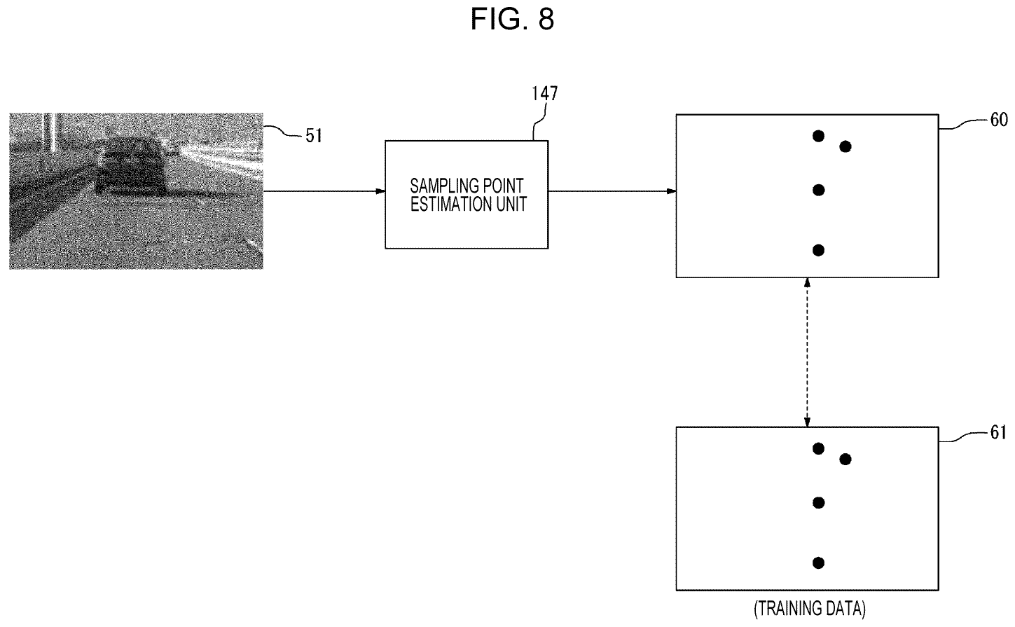

The model generation unit 148 generates the sampling point estimation model through machine learning. In this machine learning, the sparse depth data containing the calculated sampling points is used as sparse depth training data. As illustrated in FIG. 8, the model generation unit 148 generates the sampling point estimation model so that when image information (captured image 51) is inputted into the model, the model outputs the same sampling points as the sparse depth training data. For example, the model generation unit 148 may train the sampling point estimation model by treating as error the distance (degree of divergence) between a sampling point outputted by the sampling point estimation model and a sampling point in the sparse depth training data.

### Ranging Method

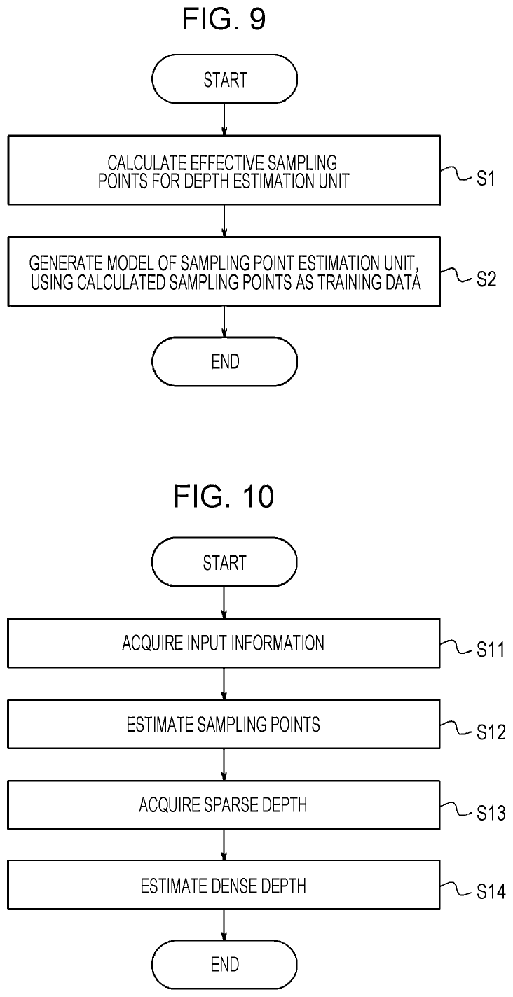

According to the present embodiment, in the learning phase, the controller 14 of the ranging device 10 generates the sampling point estimation model in accordance with the flowchart in FIG. 9, for example. According to the present embodiment, in the estimating phase, the controller 14 of the ranging device 10 executes the ranging method in the flowchart in FIG. 10, for example, to estimate output information, namely dense depth.

FIG. 9 is a flowchart illustrating a process for generating a sampling point estimation model. As described with reference to FIG. 7, the model generation unit 148 of the controller 14 calculates effective sampling points for the depth estimation unit 146 (step S1).

As described with reference to FIG. 8, the model generation unit 148 of the controller 14 generates a model for the sampling point estimation unit 147 by using the calculated sampling points as training data (step S2).

FIG. 10 is a flowchart illustrating a ranging method according to an embodiment. The input unit 141 of the controller 14 obtains input information (step S11).

The sampling point estimation unit 147 of the controller 14 estimates sampling points from the input information (step S12).

The depth estimation unit 146 of the controller 14 acquires sparse depth measured at the estimated sampling points (step S13).

The depth estimation unit 146 of the controller 14 estimates dense depth on the basis of the sparse depth (step S14).

As above, in the ranging device 10 according to the present embodiment, the sampling point estimation unit 147 estimates sampling points effective for the depth estimation unit 146 through the above configuration. Consequently, according to the present embodiment, the ranging device 10 can raise the estimation accuracy of estimating dense depth from sparse depth. The depth estimation unit 146 can be configured with a single model that estimates dense depth from sparse depth. Therefore, according to the present embodiment, the ranging device 10 can raise the estimation accuracy without performing computations using a plurality of models.

### Other Embodiments

The present disclosure has been described on the basis of the drawings and examples, but note that a person skilled in the art could easily make various variations and revisions on the basis of the present disclosure. Consequently, it should be noted that these variations and revisions are included in the scope of the present disclosure.

In the above embodiment, the input information that the input unit 141 obtains is image information, but may also be distance information (depth information) based on infrared rays detected by the first detection unit 20. The distance information to be used as input information is obtained by measurements dense enough to allow for identification of the object ob in the space.

In the above embodiment, the ranging device 10 is configured such that the mechanism that captures an image and the mechanism that measures distance using reflected waves have aligned optical axes. However, the ranging device 10 may also be configured so that these optical axes are not aligned. In other words, the mechanism that captures an image and the mechanism that estimates distance using reflected waves may simply capture the same object. However, since non-aligned optical axes may create a disparity effect, a configuration with aligned optical axes like in the above embodiment may be used in cases where higher estimation accuracy is desirable.

The above embodiment gives an example of installing the ranging device 10 in a vehicle or the like, but the ranging device 10 may be installed in any of various types of moving bodies. In the present disclosure, “moving bodies” may include not only vehicles but also aircraft, for example. Vehicles may include, for example, automobiles, industrial vehicles, railway cars, lifestyle vehicles, fixed-wing aircraft that travel on a runway, and the like. Automobiles may include, for example, passenger vehicles, trucks, buses, bicycles, trolley buses, and the like. Industrial vehicles may include, for example, industrial vehicles for agriculture and construction and the like. Industrial vehicles may include, for example, forklifts, golf carts, and the like. Industrial vehicles for agriculture may include, for example, tractors, cultivators, transplanters, binders, combines, lawn mowers, and the like. Industrial vehicles for construction may include, for example, bulldozers, scrapers, excavators, cranes, dump trucks, road rollers, and the like. Human-powered vehicles may also be included. The types of vehicles are not limited to the above examples. For example, automobiles may include industrial vehicles that can travel on roads. The same vehicle may be included in multiple types. Aircraft may include, for example, fixed-wing aircraft, rotary-wing aircraft, and the like.

The above embodiment gives an example of installing the ranging device 10 in a vehicle or the like, but a portion of the ranging device 10 may not be installed in a vehicle or the like. For example, the ranging device 10 (except for the irradiating system 111 and the light-receiving system 110) may be achieved using a remote server which is installed in a location apart from the moving body and which can communicate with the moving body. In this case, the moving body may include a communication unit and an external device. The functions of the irradiating system 111 and light-receiving system 110 of the ranging device 10 may be achieved using a separate measurement device installed in the moving body. The communication unit transmits and receives data between the moving body and the remote server. The data in this case is the data that the controller 14 transmits to, and receives from, the irradiating system 111 and the light-receiving system 110 in the above embodiment. In particular, the communication unit provided in the moving body transmits input information to the remote server and receives output information estimated on the basis of the input information at the remote server. As above, the external device provided in the moving body may control the moving body on the basis of the output information or notify a driver of the moving body on the basis of the output information. Using a remote server to achieve the ranging device 10 reduces the processing load on the moving body side and enables the allocation of resources to other control processes. By using a remote server to achieve the ranging device 10, the learning model, algorithm, or the like can be updated at the remote server. This allows for immediate updating of all moving bodies, without having to execute an update process for each moving body.

As another embodiment, processing by functional units related to dense depth estimation from among the functional units included in the controller 14 may be executed by a processor or device different from the controller 14. For example, a different processor capable of inputting and outputting data with respect to the controller 14 may include the input unit 141, the output unit 142, the depth estimation unit 146, the sampling point estimation unit 147, and the model generation unit 148. A different information processing device (as one example, a computer) capable of transmitting and receiving data with respect to the ranging device 10 may include the model generation unit 148. The different information processing device may store a trained model generated by the model generation unit 148 in the storage 112 over a network. In other words, the trained model may be generated in a different device from the ranging device 10.

In the above embodiment, the ranging device 10 is configured create distance information by direct ToF, which involves radiating laser light and directly measuring the time it takes for light to return. However, the ranging device 10 is not limited to such a configuration. For example, the ranging device 10 may create distance information by flash ToF, which involves radiating electromagnetic waves on a fixed cycle and indirectly measuring the time it takes for electromagnetic waves to return from the phase difference between the radiated electromagnetic waves and the returning electromagnetic waves. The ranging device 10 may create distance information by another ToF method, such as phased ToF, for example.

In the above embodiment, the switching unit 18 is capable of switching the direction of travel of electromagnetic waves incident on the active surface as between two directions. However, the switching unit 18 may be capable of switching the direction of travel among three or more directions rather than switching to one of two directions.

In the above embodiment, the ranging device 10 is configured such that the second detection unit 17 is a passive sensor and the first detection unit 20 is an active sensor. However, the ranging device 10 is not limited to such a configuration. For example, the ranging device 10 may be configured such that the second detection unit 17 and the first detection unit 20 are both active sensors or are both passive sensors. In both of these configurations, effects similar to the above embodiment are obtained.

Although the above embodiment describes a representative example, a person skilled in the art would clearly recognize that many changes and substitutions are possible within the gist and scope of the present disclosure. Therefore, the present disclosure is not to be interpreted as limited by the above embodiment. Various variations and changes are possible without departing from the scope of the claims. For example, in the configuration diagrams of the embodiment, a plurality of illustrated component blocks may be combined into one, or a single illustrated component block may be subdivided.

Although the present disclosure describes the solution to the problem as a device, it should be understood that the present disclosure can also be realized in a manner including the device or as a substantially corresponding method, program, or storage medium storing the program, and the scope of the present disclosure also encompasses the above.

### REFERENCE SIGNS

10 ranging device
12 irradiation unit
13 deflection unit
14 controller
15 incidence unit
16 separation unit
17 second detection unit
18 switching unit
19 first downstream optical system
20 first detection unit
50 captured image
51 captured image
60 sparse depth image
61 sparse depth image
70 dense depth image
71 dense depth image
110 light-receiving system
111 irradiating system
112 storage
141 input unit
142 output unit
143 irradiation control unit
144 light reception control unit
145 computational unit
146 depth estimation unit
147 sampling point estimation unit
148 model generation unit

1. A ranging device comprising:
an input unit that acquires input information;
a sampling point estimation unit that estimates a sampling point in distance information measured as sparse depth, the estimation being based on the input information and performed according to a designated process; and
a depth estimation unit that estimates output information, namely dense depth, on a basis of the distance information, wherein
the designated process is determined on a basis of an evaluation using a plurality of the output information estimated by the depth estimation unit.

2. The ranging device according to claim 1, wherein the designated process is determined by machine learning using training data for the sampling point, the training data being generated on a basis of the evaluation.

3. The ranging device according to claim 1, wherein the input information is image information.

4. The ranging device according to claim 1, wherein the depth estimation unit estimates the output information on a basis of the distance information and the input information.

5. A moving body comprising the ranging device according to claim 1.

6. A moving body comprising a communication unit and an external device, wherein
the communication unit transmits input information to the ranging device according to claim 1 and receives output information estimated by the ranging device on a basis of the input information, and
the external device controls the moving body on a basis of the output information or notifies a driver of the moving body on a basis of the output information.

7. A ranging method comprising:
acquiring input information;
estimating a sampling point in distance information measured as sparse depth, the estimation being based on the input information and performed according to a designated process; and
estimating output information, namely dense depth, on a basis of the distance information, wherein
the designated process is determined on a basis of an evaluation using a plurality of estimated output information.
